(19) United States
(12) Patent Application Publication
(10) Pub. No.: US 2024/0272066 A1
(43) Pub. Date: Aug. 15, 2024

(54) ACOUSTIC EXCITATION DEVICE WITH DUAL-WAVELENGTH OUTPUT

(71) Applicants: Zhenhong Yu, Arlington, MA (US); James William Assif, Baltimore, MD (US)

(72) Inventors: Zhenhong Yu, Arlington, MA (US); James William Assif, Baltimore, MD (US)

(21) Appl. No.: 18/438,513

(22) Filed: Feb. 11, 2024

Related U.S. Application Data
(60) Provisional application No. 63/485,007, filed on Feb. 15, 2023.

(51) Int. Cl. G01N 21/17

(52) U.S. Cl. CPC G01N 21/1702; G01N 2201/067; G01N 2201/0691

(57) ABSTRACT

The present disclosure is directed to a photoacoustic excitation device comprising an amplitude modulator to control emitted light beam.

### CROSS REFERENCE TO RELATED APPLICATIONS

This application claims the benefit of U.S. Provisional Application No. 63/485,007, filed on Feb. 15, 2023, which is hereby incorporated by reference in its entirety.

### FIELD OF THE INVENTION

The present disclosure relates to a device measuring or utilizing photoacoustic effect from a light source. Specifically the present disclosure relates to measuring, imaging, exciting and/or removing a variety of substances selectively and locally through use of acoustic excitation. More specifically the present disclosure related to acoustic excitation generated from the photoacoustic effect from a light source with two different wavelengths.

### BACKGROUND OF THE INVENTION

The photoacoustic (PA) effect is the generation of acoustic excitation via absorption of electromagnetic radiation by a substance. The absorbing substance can be in different forms, such as, for example, solid, liquid or gas phases. Electromagnetic radiation of different kinds can give rise to a PA effect. Examples of the electromagnetic radiation include, for example, electromagnetic frequencies from high energy sources, such as gamma radiation and X-rays, to low energy radiations, such as microwave and radio. In many applications using the PA effect, a coherent light source such as laser is utilized. The laser can be in the wavelength from ultraviolet to infrared (IR) spectral regions, including the visible region.

In order to create the PA effect, intensity of the radiation source can be modulated, either by control over the power supply of the radiation source or simply by using a rotating mechanical chopper to periodically interrupt the radiation. In this approach of PA effect generation, frequency of the generated acoustic wave is equal to the modulation frequency of the radiation source.

One of the main applications of the PA effect is photoacoustic spectroscopy (PAS), which has grown into an important tool in advanced measurement technologies since the 1970s, when newly invented powerful lasers and electrical microphones became commercially available. Currently, most modern PAS devices feature a diode or solid-state laser modulated at 100-5000 Hz and an electrical condenser or MEMS (Micro-Electro-Mechanical System) microphone. Samples are placed in an acoustic resonator designed to amplify PA wave. Since gases can readily expand when heated via the PA effect, PAS is particularly suitable for trace gas analysis. Liquid and solid samples can also be analyzed by PAS, by measuring acoustic signals generated after receiving conducted heat from the illuminated sample surface.

In addition to the PAS method, another application of the PA effect is photoacoustic imaging (PAI), in which an ultrasonic wave is generated with a pulsed laser. The time-resolved PA signals are detected with the same equipment used in the ultrasonic imaging, to depict internal structure of the targeted biological tissues. The first set of convincing PAI images of blood vasculature were obtained from living subjects around 2003. From then on, the technology has grown dramatically in terms of instrumentation, image reconstruction, and new functional and molecular capabilities. Preclinical PAI has gathered momentum and has begun to be accepted by the biomedical society.

### SUMMARY OF THE INVENTION

An improved photoacoustic instrument and methods of configuration and operation thereof are provided for exciting, or measuring, or removing a light-absorbing substance in a gas, a liquid or a solid. The instrument may employ a pair of lasers that emit light beams at different wavelengths. Use of amplitude modulation with a phase shift on the two lasers allows interference from background absorption to be cancelled out. The instrument may also employ a photodetector and a microphone to enable real-time adjustment of the amplitude modulation on the lasers to achieve the best performance.

In one specific example embodiment, herein provides a method for measuring ammonia in humid air. Ammonia and water have different IR spectra due to molecular vibrations, thus using two lasers at two different wavelengths, at which ammonia and water absorb differently, the PA effects from water vapor at any concentrations may be cancelled out via appropriate amplitude modulation on the lasers. The instrument could therefore exclusively measure the PA effect from ammonia in the samples.

In another embodiment, herein provides a method for performing site-specific laparoscopic surgery when the radiation triggers micro bubbles to act as a scalpel to remove body tissues, such as, for example, a small piece of tissue or an artery plaque. More specifically, a radiation beam can be used to generate/move/enlarge/collapse ultrasonic micro bubbles (or ultrasonic cavitations) at specific site inside a patient's body with minimal damage to the surrounding tissues.

In one aspect of the disclosure, herein provided a photoacoustic system comprising: (a) an amplitude modulator, the amplitude modulator being configured to modulate (i) a first amplitude and a first phase of a first light beam, and (ii) a second amplitude and a second phase of a second light beam; and (b) a light transmitter linked to the amplitude modulator, the light transmitter being configured to collimate and merge the first light beam and the second light beam, thereby producing a merged single beam.

In another aspect of this disclosure, herein provides a photoacoustic system comprising: (a) an amplitude modulator, the amplitude modulator being configured to modulate (i) a first amplitude and a first phase of a first light beam, and (ii) a second amplitude and a second phase of a second light beam; (b) a light transmitter linked to the amplitude modulator, the light transmitter being configured to collimate and merge the first light beam and the second light beam, thereby producing a merged single beam, wherein the light transmitter comprises a beam splitter configured to reflect a first fraction of the merged single beam in a first direction and direct a second fraction of the merged single beam to a second direction; (c) a photodetector linked to the light transmitter, the photodetector being configured to monitor the first fraction of the merged single beam at a rate from 50 Hz to 2 GHz in real time; (d) an acoustic signal monitor, the acoustic signal monitor being configured to monitor acoustic signals generated by the second fraction of the merged single beam; and (e) a data processor linked to the amplitude modulator, the photodetector, and/or the acoustic signal monitor, the data processor being configured to (i) analyze data received from the photodetector and/or the acoustic signal monitor, and (ii) provide feedbacks to the amplitude modulator in real time.

In some embodiments, each of the photoacoustic systems disclosed above further comprises: a light source linked to the amplitude modulator, the light source being configured to emit at least the first light beam and the second light beam. In some embodiments, the light source is configured to produce continuous-wave light outputs at spectral region from ultraviolet to far-IR.

In still another aspect of this disclosure, herein provides a photoacoustic system, comprising: (a) a first light source and a second light source, wherein the first light source emits a first light beam, wherein the second light source emits a second light beam; (b) an amplitude modulator coupled to the first and second light sources, the amplitude modulator being configured to modulate (i) a first amplitude and a first phase of the first light beam, and (ii) a second amplitude and a second phase of the second light beam; (c) a light transmitter, the light transmitter being configured to collimate and merge the first light beam and the second light beam, thereby producing a merged single beam, wherein the light transmitter comprises a beam splitter configured to reflect a first fraction of the merged single beam in a first direction and direct a second fraction of the merged single beam to a second direction; (d) a photodetector coupled to the light transmitter, the photodetector being configured to monitor the first fraction of the merged single beam at a rate from 50 Hz to 2 GHz in real time; (e) an acoustic signal monitor, the acoustic signal monitor being configured to monitor acoustic signals generated by the second fraction of the merged single beam; and (f) a data processor linked to the amplitude modulator, the photodetector, and/or the acoustic signal monitor, the data processor being configured to (i) analyze data received from the photodetector and/or the acoustic signal monitor, and (ii) provide feedbacks to the amplitude modulator in real time.

In some embodiments, each of the first light source and the second light source is configured to produce continuous-wave light outputs at spectral region from ultraviolet to far-IR. In some embodiments, the first and second light beams are distributed feedback (DFB) semiconductor lasers. In some embodiments, the light source is configured to tune a first wavelength of the first light beam and the second wavelength of the second light beam, wherein the first light source is configured to tune the first wavelength of the first light beam, and wherein the second light source is configured to tune the second wavelength of the second light beam. In some embodiments, the first fraction of the merged single beam is from 1% to 15% of the merged single beam, and wherein the second fraction of the merged single beam is from 85% to 99% of the merged single beam. In some embodiments, the first fraction of the merged single beam is about 10% of the merged single beam, and wherein the second fraction of the merged single beam is about 90% of the merged single beam. In some embodiments, the first amplitude is modulated with a first sinusoidal function, and wherein the second amplitude is modulated with a second sinusoidal function. In some embodiments, the difference between the first phase and the second phase is about 180 degree. In some embodiments, the difference between the first phase and the second phase is from 175 degree to 185 degree.

In some embodiments of all of the above photoacoustic systems, the amplitude modulator comprises one or more quartz crystal oscillators configured to generate waveforms of a sinusoidal-wave output or a square-wave output. In some embodiments of all of the above photoacoustic systems, the photoacoustic system further comprises: one or more capacitor couplers, each of the one or more capacitor couplers being configured to couple the waveforms of the sinusoidal-wave output or the square-wave output to one or more DC currents, respectively, wherein each of the DC currents is the DC power supply for the light source, the first light source, or the second light source. In some embodiments of all of the above photoacoustic systems, the photoacoustic system further comprises an optical fiber coupler and a single-mode optical fiber, wherein the merged single light beam or the second fraction of the merged single light beam is coupled to the single-mode optical fiber via the optical fiber couple. In some embodiments, the optical fiber comprises numeric aperture of 0.22, and wherein the optical fiber is terminated with a physical contact (PC) polish connector at each end. In some embodiments, the acoustic signal monitor is a microphone or several microphones in an array configuration.

In still another aspect of this disclosure, herein provides a method of modulating light beams for a photoacoustic system, comprising: (a) obtaining a first absorption spectrum of a sample and a second absorption spectrum of a surrounding medium of the sample; (b) at least based on the first and second absorption spectra, selecting (i) a first wavelength, wherein the sample exhibits a detectable first absorbance at the first wavelength, and wherein the surrounding medium exhibits a detectable second absorbance at the first wavelength; and (ii) a second wavelength, wherein the sample exhibits a detectable third absorbance at the second wavelength, wherein the surrounding medium exhibits a detectable fourth absorbance at the second wavelength, wherein the third absorbance is no more than 10% of the first absorbance, and wherein the fourth absorbance from 95% to 105% of the second absorbance; (c) providing a first modulated light beam having the first wavelength and a second modulated light beam having the second wavelength, wherein the second modulated light beam is phase shifted from the first modulated light beam; (d) merging and collimating the first and second modulated light beams, thereby providing a merged single light beam; and (e) radiating a first fraction of the merged single light beam on the sample and the surrounding medium.

In some embodiments, the method further comprises: after (d) and before (e): splitting the merged single light beam into at least the first fraction and a second fraction; and sampling the second fraction by a photodetector at a sampling frequency from 50 Hz to 2 GHz. In some embodiments, the method further comprises: after the sampling, providing feedback information to an amplitude modulator; and modulating, by the amplitude modulator and based on at least the feedback information, the first and/or second modulated light beams. In some embodiments, the method further comprises: after (d) and before (e): radiating the first fraction of the merged single light beam on the surrounding medium; monitoring, by an acoustic signal monitor, a medium acoustic excitation generated from the surrounding medium; and further modulating, by the amplitude modulator and based on the medium acoustic excitation, the first and/or second modulated light beams. In some embodiments, the modulating is performed mechanically and/or electronically, and wherein the amplitude modulator varies an amplitude and a phase of the first modulated light beam or the second modulated light beam. In some embodiments, the modulating is performed electronically by a transistor-transistor logic signal carrying information of a modulation frequency, a depth and the phase of the first modulated light beam or the second modulated light beam. In some embodiments, the second modulated light beam is phase shifted from the first modulated light beam by about 180 degree. In some embodiments, the second modulated light beam is phase shifted from the first modulated light beam from 175 degree to 185 degree. In some embodiments, the first and second modulated light beams are modulated at the same or substantially the same modulation frequency. In some embodiments, the first and second modulated light beams are modulated at a modulation frequency from 10 kHz to 100 kHz. In some embodiments, the first modulated light beam is modulated by a first injection current, wherein the second modulated light beam is modulated by a second injection current, and wherein each of the first injection current and the second injection current independently comprises a sinusoidal or square waveform signal. In some embodiments, photoacoustic effects on the medium from the first and second wavelengths are the same or substantially the same. In some embodiments, the photoacoustic system comprises the amplitude modulator and the acoustic signal monitor.

It should be understood that a variety of additional features and alternative embodiments may be implemented other than those discussed in this Summary. This Summary is intended simply as a brief introduction to the readers for the further description which follows, and does not indicate or imply that the examples mentioned herein cover all aspects of the disclosure, or are necessary or essential aspects of the disclosure.

### BRIEF DESCRIPTION OF THE DRAWINGS

FIG. 1: shows a schematic block diagram of an example of a dual-wavelength PA device;

FIG. 2: shows a schematic block diagram of another example of a dual-wavelength PA device with an optical and acoustic monitoring apparatus;

FIG. 3 shows an example of the selection of the two utilized wavelengths in the present disclosure;

FIG. 4 shows another example of the selection of the two utilized wavelengths;

FIG. 5: demonstrates a flow diagram of an example sequence of steps for a configuration and operation of the example dual-wavelength PA device of FIGS. 1 and 2.

### DETAILED DESCRIPTION OF THE INVENTION

While preferred embodiments of the present disclosure have been shown and described herein, it will be obvious to those skilled in the art that such embodiments are provided by way of example only. Numerous variations, changes, and substitutions occur to those skilled in the art without departing from the disclosure. It should be understood that various alternatives to the embodiments of the disclosure described herein can be employed in practicing the disclosure. It is intended that the following claims define the scope of the disclosure and that methods and structures within the scope of these claims and their equivalents be covered thereby.

For both the PAS and PAI techniques, one critical limitation of the applications is the requirement of non-absorption of the surrounding medium of the samples. The reason is that if the medium has a high absorptive capability of the radiation, the medium could generate a strong PA background which can mitigate the detection or imaging of the targeted samples, especially for biological tissues.

In some embodiments, a photoacoustic excitation device comprises an amplitude modulator and a light transmitter. In some embodiments, the photoacoustic excitation device is configured to modulate two lasers with different wavelengths as the excitation light sources. In some embodiments, the amplitude modulator is configured to modulate the amplitude of the lasers. In some embodiments, the light transmitter is configured to guide the modulated lasers through series of optics and provide optical radiation directly to a sample and its surrounding medium. In some embodiments, the optical radiation is absorbed by the sample and medium materials. In some embodiments, the photoacoustic excitation device emits light beams configured to produce selective and localized acoustic excitation in samples, including biological samples. In some embodiments, the amplitude modulator is configured to apply a differential amplitude modulation scheme and control light intensities and phases of the laser beams as well as the modulation frequency. In some embodiments, acoustic excitation up to ultrasonic frequencies via the photoacoustic effect is locally created on the target samples, while damages to the surrounding medium or mitigation of the PAS effect by the surrounding medium are minimized or eliminated.

The present disclosure provides a flexible optical fiber-based photoacoustic system configured to generate precise acoustic waves on the targeted samples, locally and selectively. The acoustic waves are generated no matter whether the surrounding medium has absorptive capability or not. The disclosed device and instrument employs PA effect to generate sonic or ultrasonic excitation using a combination of light sources at dual or multiple wavelengths. The disclosed device and instrument employ an amplitude modulation scheme that controls both amplitude and phase of the light sources. The amplitude and phase modulation allows mitigating or eliminating of the PA backgrounds generated from the medium, thereby enhancing the signal-to-noise ratio of the detection or imaging of the targeted samples from the PA signals.

### Instrument Overview

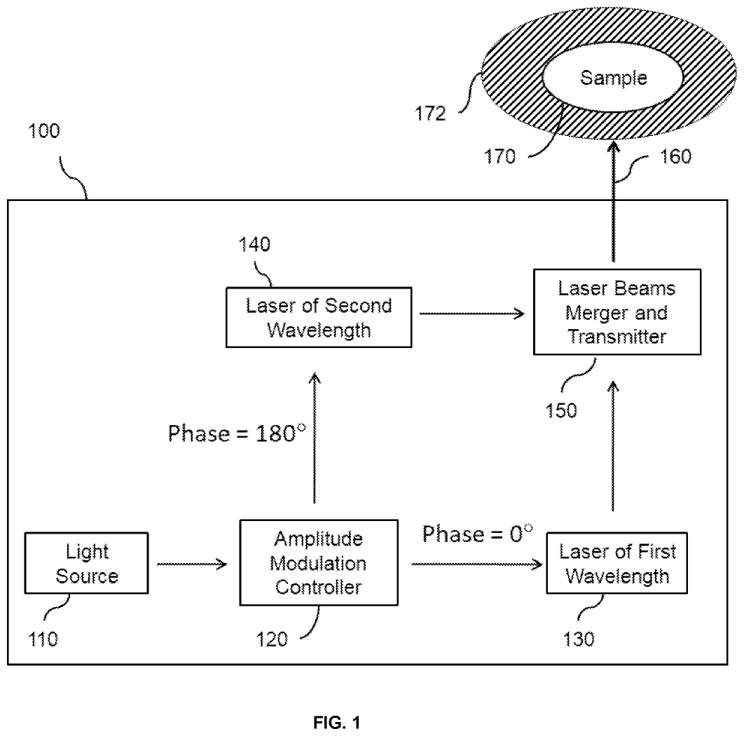

FIG. 1 is a schematic block diagram of an example of a dual-wavelength PA device 100. The PA device 100 can be used to generate acoustic excitation, selectively and locally, at the targeted sample 170 with reduced or little radioactive or mechanical damages to the surrounding medium 172. In one embodiment as shown in FIG. 1, discussed in more details below, the target sample 170 is surrounded by absorptive medium 172 in liquid phase. Unless stated otherwise, the sample can be in gas, liquid or solid phase. Therefore, it should be understood that the photoacoustic system disclosed herein can be configured for samples in gas, liquid and solid phases.

The dual-wavelength PA device 100 comprises light source 110, which can produce two or more lasers or other incoherent light sources, such as, for example, light emitting diodes (LEDs), which have different wavelengths in any spectral region from ultraviolet to far-Infrared. The dual-wavelength PA device 100 further comprises (i) an amplitude modulation controller 120 (also called an amplitude modulator), which can be a laser power modulation and control device, and (ii) a light transmitting device 150 (also called a light transmitter), which can be a laser beams merger and transmitter. Two laser beams from the light source 110 are differentially modulated and the modulation process is controlled by amplitude modulation controller 120 to produce a first laser 130 and a second laser 140. The first laser 130 is of the first wavelength and with phase=0°, while the second laser 140 is of the second wavelength with phase=180º. The first laser 130 and the second laser 140 are merged into a single light beam 160 via a set of dichroic optical components in the light transmitting device 150. The single light beam 160 is applied to the sample 170 which is surrounded by the medium 172. It should be noted that the light source 110 can be a stand-alone unit. Thus, the dual-wavelength PA device 100 may not comprise a light source. Rather, the dual-wavelength PA device 100 is connected with an external light source and receives two or more lasers with different wavelengths.

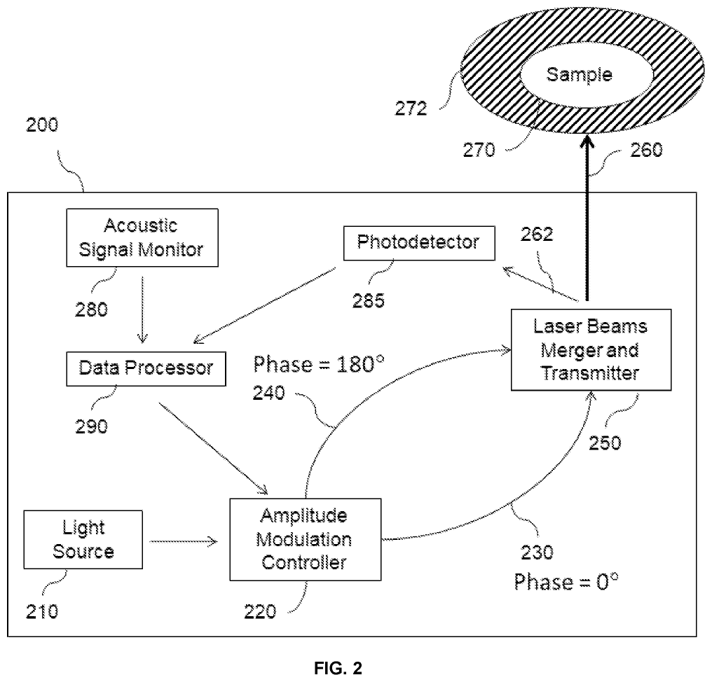

In another embodiment, FIG. 2 shows a schematic block diagram of another example of a dual-wavelength PA device 200. The dual-wavelength PA device 200 comprises light source 210, which can be two or more lasers or other incoherent light sources, such as, for example, light emitting diodes (LEDs), which have different wavelengths in any spectral region from ultraviolet to far-IR. The dual-wavelength PA device 200 further comprises (i) an amplitude modulation controller 220 (also called an amplitude modulator), which can be a laser power modulation and control device, and (ii) a light transmitting device 250 (also called a light transmitter), which can be a laser beams merger and transmitter. Two laser beams from the light source 210 are differentially modulated and the modulation process is controlled by amplitude modulation controller 220 to produce a first laser 230 and a second laser 240. The first laser 230 is of the first wavelength and with phase=0°, while the second laser 240 is of the second wavelength with phase=180°. The first laser 230 and the second laser 240 are merged into a single light beam 260 via a set of dichroic optical components in the light transmitting device 250. The single light beam 260 is applied to the sample 270 which is surrounded by the medium 272. It should be noted that the light source 210 can be a stand-alone unit. It should be noted that the light source 210 can be a stand-alone unit. Thus, the dual-wavelength PA device 200 may not comprise a light source. Rather, the dual-wavelength PA device 200 is connected with an external light source and receives two or more lasers with different wavelengths.

The dual-wavelength PA device 200 further comprises a fast-response photodetector 285, an acoustic signal monitor 280, and a data processor 290, which can be a data analysis and processing device, to monitor and analyze instrumental operation and performance of the dual-wavelength PA device 200 in real-time.

For example, the merged single light beam 260 can pass through the light transmitting device 250, which can comprise a 90/10 beam splitter. The 90/10 beam splitter produces two beams: 10% of the laser output becomes light beam 262, which can be reflected to the photodetector 285 for monitoring; and 90% of the laser output becomes the single light beam 260 which enters into a bundle of optical fibers leading to the sample 270.

During the modulation process, amplitude and phase of the laser outputs can be adjusted via the amplitude modulation controller 220 in the frequency range from about 10 Hz to about 400 MHz. The merged laser beam after the modulation can be monitored in real-time by detecting the 10%-output laser beam 262 via the photodetector 285 at a sampling rate from about 50 Hz to about 2 GHz. The photodetector signal from the photodetector 285 can be sent to the data processor 290, such as, for example, a computer or a cell phone, for further analysis in order to adjust and maximize the instrument performance correspondingly.

The merged 90%-output laser beam 262 can be further processed by the light transmitting device 250. The light transmitting device 250 comprises optical fibers of specific length and numerical aperture (NA), and other optical components, such as, for example, beam collimator, optical couplers, and narrowband filters. The light transmitting device 250 is configured to transmit the laser light beam to the targeted sample 270, wherein the target sample 270 can be in gas, liquid, and solid phases.

### Excitation Light Sources

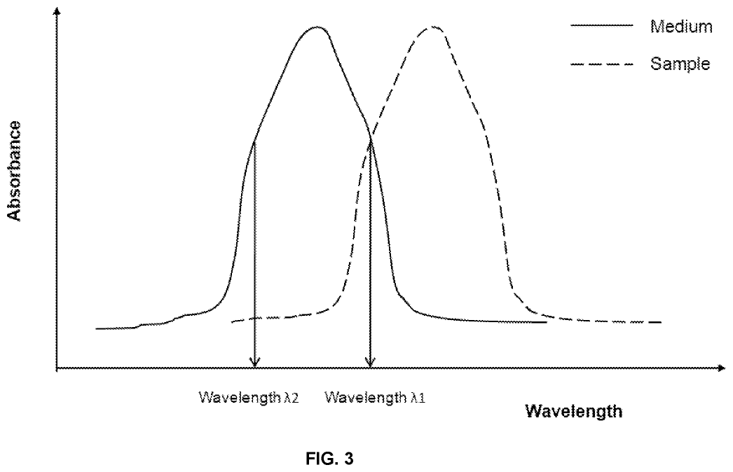

FIG. 3 demonstrates the selection of the two utilized wavelengths (wavelength λ₁ and wavelength λ₂) in the present disclosure. To use the dual-wavelength PA device, absorption spectra of the targeted sample and the surrounding medium are taken and analyzed. This technique can be useful for the situation in which the targeted sample and the surrounding medium have overlapping absorption features, such as, for example, those in many biological systems. As shown in FIG. 3, the absorbance of the medium at wavelength λ₁ is the same as or substantially the same as the absorbance at wavelength λ₂. In addition, at wavelength λ₁ the absorbance of the sample and that of the medium are substantially the same. At wavelength λ₂ the absorbance of the medium is substantially higher than the absorbance of the sample so that at wavelength λ₂, the contribution of the sample to the measured absorbance can be small enough to ignore.

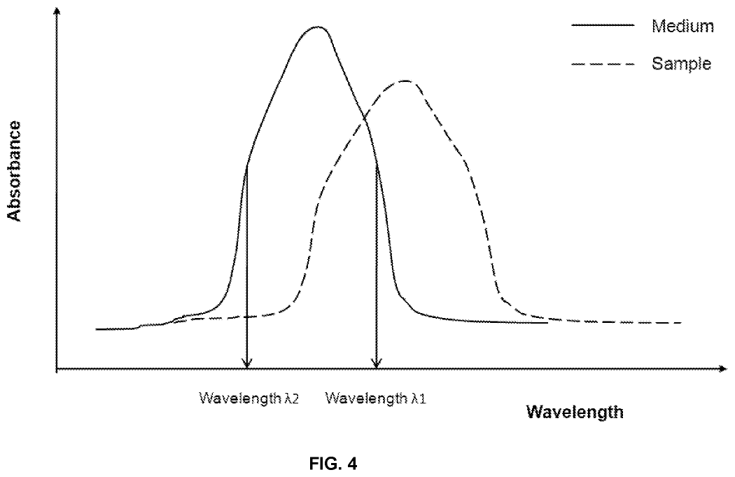

FIG. 4 shows another example of how to choose the wavelengths for the laser source. For the medium the absorbance at wavelength 2 and at wavelength λ₂ are substantially the same. For the sample the absorbance at wavelength 2 is substantially higher than that at wavelength λ₂ so that the differentials of absorbance between absorbance at wavelength λ₁ and the absorbance at wavelength λ₂ is substantially the same as the absorbance at wavelength M.

These features of the laser with wavelength 2 and the laser with wavelength λ₂ with respect to the sample and the medium can be used to reduce or cancel the background contribution of medium from the absorbance of the sample as shown below.

In one embodiment, the light sources may have two distributed feedback (DFB) semiconductor lasers or other types of lasers that can produce continuous-wave light outputs at any spectral region from ultraviolet to far-IR. Using a Bragg diffraction grating device that provides periodic changes in the refractive index causing an optical feedback into the cavity of the laser, the DFB laser has a stable single wavelength emission profile as desired in this disclosure.

The DFB laser also has other advantages, such as, for example, wavelength tunability that allows the laser wavelength to be adjusted via a precise control of the DFB laser temperature. This wavelength tunability of the DFB laser could enhance the effect of the two-wavelength PA technique, especially in minimizing the thermal damage due to the PA effect to the surrounding tissues of the target in the medium. Another advantage of the DFB laser is that its output is stable over a long period of time with good beam quality. The very small beam divergence may permit the application of the dual-wavelength PA device on the samples of very small size.

### Dual-Wavelength Differential Amplitude Modulation

The fundamental concept of this disclosure is that, on the one hand, the PA effects on the medium from the two wavelengths are substantially the same, which can be cancelled out by each other, if applying a 180-degree phase difference to the two-laser modulation. On the other hand, the absorption capabilities of the sample at the two wavelengths are different, which can generate a differential PA effect after the modulation. For example, if the two lasers with identical intensities at the two wavelengths, λ₁ and λ₂, are amplitude modulated with a sinusoidal function, then the light intensity of the two lasers respectively becomes:

$${I}^{1} = {I}_{0} \times sin ( t ) \qquad ( 1 )$$

$${I}^{2} = {I}_{0} \times sin ( t + 180 ° ) \qquad ( 2 )$$

Here I₀ is the continuous laser intensity with modulation. According to the Beer-Lambert law, the radiation energy absorbed by the medium at λ₁ and λ₂ can be expressed respectively, as:

$${E}^{1} = {I}^{1} {ε}^{I} cl = {I}_{0} {ε}^{1} c l \times sin ( t ) \qquad ( 3 )$$

$${E}^{2} = {I}^{2} {ε}^{2} c l = - {I}_{0} {ε}^{2} c l \times sin ( t ) \qquad ( 4 )$$

With regard to the medium, variable c is the concentration of medium, variable 1 is the optical path length, and ε¹ and ε² are the absorptivity of the medium at λ₁ and λ₂. Since λ₁ and λ₂ are selected to allow ε¹=ε² or substantially the same, the total energy absorbed by the medium, which is the sum of E¹ and E², can be zero, or substantially zero.

With regard to the target sample, variable c is the concentration of sample, variable/is the optical path length, and, as explained above, ε¹ are much larger than ε², based on the selection of λ₁ and λ₂ according to the absorption spectrum of the sample at wavelength λ₁ and wavelength λ₂. Thus, E² is negligible compared to E¹, which enables the PA effect from the laser excitation at λ₁ be dominant.

In one embodiment, the output amplitudes of the two DFB lasers that emit near-IR (NIR) light beams at different wavelengths are modulated at the identical frequency, in the range of from 10 Hz to 100 kHz, from 10 Hz to 20 Hz, from 20 Hz to 30 Hz, from 30 Hz to 40 Hz, from 40 Hz to 50 Hz, from 50 Hz to 60 Hz, from 60 Hz to 70 Hz, from 70 Hz to 80 Hz, from 80 Hz to 90 Hz, from 90 Hz to 100 Hz, from 100 Hz to 200 Hz, from 200 Hz to 300 Hz, from 300 Hz to 400 Hz, from 400 Hz to 500 Hz, from 500 Hz to 600 Hz, from 600 Hz to 700 Hz, from 700 Hz to 800 Hz, from 800 Hz to 900 Hz, from 900 Hz to 1 kHz, from 1 kHz to 2 kHz, from 2 kHz to 3 kHz, from 3 kHz to 4 kHz, from 4 kHz to 5 kHz, from 5 kHz to 6 kHz, from 6 kHz to 7 kHz, from 7 kHz to 8 kHz, from 8 kHz to 9 kHz, from 9 kHz to 10 kHz, from 10 kHz to 20 kHz, from 20 kHz to 30 kHz, from 30 kHz to 40 kHz, from 40 kHz to 50 kHz, from 50 kHz to 60 kHz, from 60 kHz to 70 kHz, from 70 kHz to 80 kHz, from 80 kHz to 90 kHz, from 90 kHz to 100 kHz, from 10 kHz to 30 kHz, from 20 kHz to 40 kHz, from 30 kHz to 50 kHz, from 40 kHz to 60 kHz, from 50 kHz to 70 kHz, from 60 kHz to 80 kHz, from 70 kHz to 90 kHz, from 80 kHz to 100 kHz, from 10 kHz to 40 kHz, from 20 kHz to 50 kHz, from 30 kHz to 60 kHz, from 40 kHz to 70 kHz, from 50 kHz to 80 kHz, from 60 kHz to 90 kHz, from 70 kHz to 100 kHz, from 10 kHz to 50 kHz, from 20 kHz to 60 kHz, from 30 kHz to 70 kHz, from 40 kHz to 80 kHz, from 50 kHz to 90 kHz, from 60 kHz to 100 kHz, from 10 kHz to 60 kHz, from 20 kHz to 70 kHz, from 30 kHz to 80 kHz, from 40 kHz to 90 kHz, from 50 kHz to 100 kHz, from 10 kHz to 70 kHz, from 20 kHz to 80 kHz, from 30 kHz to 90 kHz, from 40 kHz to 100 kHz, from 10 kHz to 80 kHz, from 20 kHz to 90 kHz, from 30 kHz to 100 kHz, from 10 kHz to 90 kHz, from 20 kHz to 100 kHz, or from 10 kHz to 100 kHz.

Absorption of the modulated laser beam by the absorbing tissues generates acoustic wave when the radiative energy is transferred into sound during molecular energy relaxation. Frequency of the acoustic wave is the same as the laser modulation frequency. This phenomenon is the results of the photoacoustic effect.

In one embodiment, the amplitude modulation of a DFB laser is performed under the direct modulation of its injection current. In this approach, the function generator uses a quartz crystal oscillator and generates the waveform as a sinusoidal or square-wave output. This waveform signal is coupled to a direct current (DC) via a capacitor coupler. Then the coupled DC current is injected to the DFB laser as its DC power supply.

Further, in another embodiment, although amplitudes of the laser outputs from the two DFB lasers can be the same or different, the phases of the laser outputs are differentiated by 180°. A photodetector can be used to monitor the merged laser beam in real-time before it is coupled into a single-mode or multi-mode optical fiber. Waveform of the merged laser beam is a flat line with constant intensity and no periodic information.

### Light Transmitter or Light Transmission System

In one embodiment, the light transmitter or light transmission system is utilized to effectively transmit and merge the modulated laser beams into one beam and transmit the merged beam to the targeted sample.

In another embodiment, the laser beams emitted from each DFB laser, after the amplitude modulation, is collimated via an aspheric lens. The collimated laser beams are merged into a single beam by a dichroic optical prism. After the merging of the two laser beams, a 10/90 beam splitter is utilized to reflect 10% of the merged light beam to a photodetector, which is sampling at a rate up to 2 GHz to monitor the effect of laser modulation in real-time. The remaining 90% of the merged light beam passes through the beam splitter. Then the 90% of the merged light beam is coupled via a precisely positioned optical fiber coupler into a 100 μm single-mode optical fiber that transmits the 90% merged light beam to the targeted sample. Numeric aperture (NA) of the optical fiber can be 0.22 or higher and the length of the optical fiber may depend on the operation requirement. The optical fiber is terminated with a physical contact (PC) polish connector at each end.

### Photodetector

A photodetector, also called a photosensor, is an optoelectronic device that converts incident light or other electromagnetic radiation in the UV, visible, and infrared spectral regions into electrical signals. There is a variety of photodetectors which may be classified by mechanism of detection, such as photoelectric or photochemical effects, or by various performance metrics, such as spectral response. Semiconductor-based photodetectors can be a photo detector having a p-n junction that converts light photons into current. The absorbed photons make electron-hole pairs in the depletion region. Photodiodes and photo transistors are a few examples of photo detectors.

In some instances, to modulate the laser(s) precisely and stably, a square-wave Transistor-Transistor Logic (TTL) output from a custom-designed function generator is connected to the laser DC power supply. The frequency of the TTL output is locked at the targeted laser modulation frequency. At the end of the optical pass, a fast-response specific wavelength enhanced Si photovoltaic detector or other photodetectors matching the laser wavelength is used to monitor the laser output. An optical density (OD)=2 neutral density filter is placed in front of the photodetector to prevent signal saturation.

### Acoustic Signal Monitor

An acoustic signal monitor may be a microphone or several microphones in an array configuration. The acoustic signal monitor is configured to monitor the acoustic excitation generated by the radiation beams on the medium substances and/or the sample. PA signals received by the acoustic signal monitor can be analyzed. For example, when the radiation of the merged single beam is radiated on the medium only, the received PA signals can be used to further modulate the light beams such that the received PA signals are negligible or below the detection limit of the acoustic signal monitor. This can be achieved by varying amplitude of the radiation intensity and the phase of one of the light beams before merging the light beams.

### Methods of Configuration and Operation

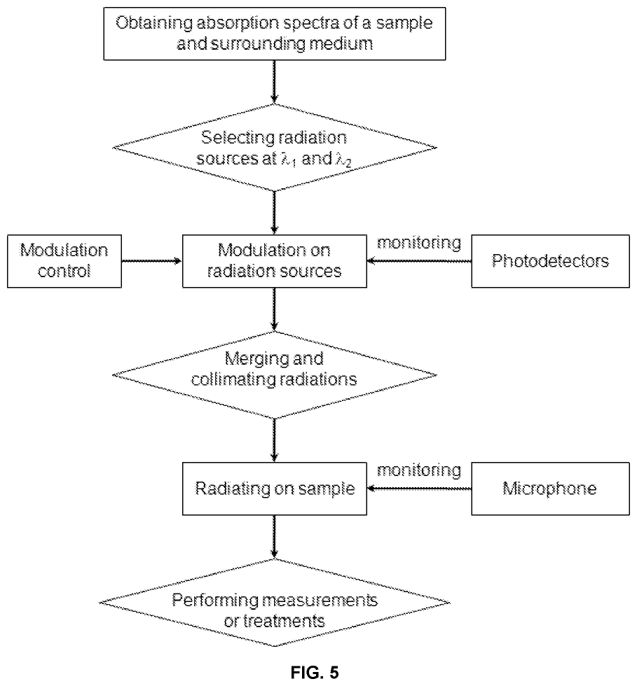

FIG. 5 is a flow diagram of an example sequence of steps for configuration and operation of the example dual-wavelength PA devices of FIGS. 1 and 2.

At Step 510, the absorption spectra of the medium and the sample are taken. According to the wavelength of the interested spectral region, a commercially available ultraviolet/visible (UV/vis) spectrometer or a Fourier Transformer Infrared (FTIR) spectrometer can be employed. These spectrometers have been used for the determination of absorptivity of species in gas, liquid, and solid phases.

After the determination of the absorption spectra of the sample and the medium in Step 510, operational wavelengths of the dual-wavelength PA device can be selected, based on quantitative comparison and analysis on the absorptivities of the medium and the sample substances in Step 520. In one embodiment, the selection rules for wavelength selection can be that, for the medium, the absorptivity at both wavelengths may be identical, or at least substantially similar; while for the sample, the absorptivities at both wavelengths can be very different such that the absorptivity at one wavelength can be small enough to be ignored. Following the selection of two wavelengths in Step 520, two continuous-wave radiation sources that can emit appreciable radiation outputs at the selected wavelengths respectively, may be utilized for the dual-wavelength PA device.

At the Step 530, the selected radiation beams from the radiation sources such as the DFB lasers or LEDs may be amplitude modulated (AM) either mechanically or electronically by an AM control device 534 (also called an amplitude modulator). The mechanical modulation can be achieved by using a mechanical chopper that periodically interrupts the radiation beam. The electronically modulation may be performed via a Transistor-Transistor Logic (TTL) signal that carries the information of modulation frequency, depth and phase. The TTL signal may be sent from the AM control device 534 to the power supply of the radiation source. Thus, the AM control can vary the amplitude and the phase of the two radiations as well as modulation frequency simultaneously. The modulated radiation beams may be monitored by one or more photo detectors 532 to provide feedback information to the AM control device 534 in order to achieve the adjustment of the modulation in real-time.

At Step 540, the modulated radiation beams may be collimated via a single aspheric lens or a two-lens system, depending on the divergence of the radiation source. In one embodiment, the two-lens system is used to expand or shank the beam diameter of the collimated beam if a different beam diameter is necessary. Of the two-lens system, one lens can have a negative focal length while the other can be with a positive focal length.

After merging and collimating of the modulated laser beams in Step 540, a lens with a long positive focal length may be used to guide the collimated beam into one or a bundle of multi-mode optical fibers with the right spectral transmission and bandwidths for the laser beams. The optical fiber may transmit the modulated laser beams in a distance from several centimeters to tens of meters. At the other end of the optical fiber, another lens of a positive focal length may be applied to guide the laser beams to the sample through the surrounding medium.

Before radiating on the sample in Step 540, another monitoring step may be taken by only radiating on the medium. A microphone 552 or several microphones 552 in an array configuration may be used to monitor the acoustic excitation generated by the radiation beams on the medium substances. Additional adjustment to the modulation control may be applied to mitigate the PA effect on the medium by varying amplitude of the radiation intensity and the phase of modulation. The goal of this medium testing step is to confirm that the background PA signal of the medium can be cancelled out using the two selected wavelengths according to the present disclosure.

At Step 560, a measurement or a treatment is performed via the acoustic excitation generated on the sample. In some applications, an acoustic cavity may be applied to enhance the PA effect on the samples, especially for the measurements of trace species.

Use of dual-wavelength background-cancellation approach can permit mitigating acoustic interference from background absorption during the applications of the PA effect to the sample. For example, in the PA measurement of trace ammonia (NH₃, sample) in the ambient air samples, water (H₂O, medium) content in the samples, which may have similar absorptive feature and capability as NH₃ in the mid-IR spectral region, and thereby contribute to the acoustic signals in the PA measurement. When two wavelengths are selected according to the present disclosure and based on the differences in absorption features between H₂O (medium) and NH₃ (sample), the massive acoustic background from the PA effects on H₂O can be cancelled out due to the differential modulation at the two selected wavelengths. Thus, even though the NH₃ PA signals may be less than one percent of that of H₂O, the NH₃ PA signals could still be measured with a reasonable signal-to-noise ratio.

### Discussions

The present disclosure details apparatus and methods for applications in measurements, imaging and treatments of biological samples using the PA effect. It should be understood that various adaptations and modifications may be made to what has been described above, to suit various requirements of the task. For example, while it is discussed above that the acoustic excitation may be generated by two DFB lasers, it should be understood that other types of light sources, such as, for example, LEDs or other light sources, may be configured to emit light at certain wavelengths and may be used according to the devices and methods disclosed herein.

Further, different aspects of the apparatus, or various method steps, may be used in isolation or in various combinations with other apparatus or steps. For example, the phase differences between the modulations of the two radiation sources may be different from 180°, if there is a phase shift during the absorption of the radiation. Likewise, radiation sources at frequencies outside of the spectral region from ultraviolet to far-IR may be used in an instrument that may be applied to the samples having absorptive capability at such frequencies. Further, many other additions may be made to the techniques. For example, while it is described above that lasers of the identical output powers may be used, it should be understood that, in alternative embodiments, radiation sources of different output powers may also be used. It should be understood that the above descriptions are for examples only. Many other embodiments following the same principle disclosed herein to cancel the medium background signals are possible.

### Applications

In some embodiments, the devices and methods disclosed herein can be applied to measurements of an analyte in a medium wherein background of the medium interferes with the measurement of the analyte. More specifically, when measuring a trace amount of an analyte, the interference of the background signals from the medium can be canceled out using the devices and methods disclosed herein. For example, a wavelength Mu can be chosen for the analyte for better measurements of its signals. Then a wavelength λ₂ can be chosen so that the absorptivities of the medium at wavelength Au and wavelength λ₂ are the same or substantially the same, while the absorptivity of the analyte at wavelength λ₂ can be negligible when compared with the absorptivity of the analyte at wavelength λ₁. One example of such an application is to measure a trace amount of ammonia (NH₃) in water (H₂O) medium.

In some embodiments, the devices and methods disclosed herein can be applied to photoacoustic imaging of biological samples. More specifically, when imaging a biological sample target in its natural medium, the interference of the background signals from the natural medium can be canceled out using the devices and methods disclosed herein. For example, a wavelength λ₁ can be chosen for the biological sample target for better measurements of its signals. Then a wavelength λ₂ can be chosen so that the absorptivities of the natural medium at wavelength λ₁ and wavelength λ₂ are the same or substantially the same, while the absorptivity of the biological sample target at wavelength λ₂ can be negligible when compared with the absorptivity of the biological sample target at wavelength λ₁. One example of such an application is to image tumor cells among normal cells with or without contrasting agents. Diagnostic imaging modalities have helped detect and characterize cancer, aiding both in early detection and providing information to guide proper treatment decisions. Advancements in imaging techniques have broadly improved outcomes related to survival of specific cancers as well as reduced the associated costs of treatment. PA imaging and the devices and methods embodied here can provides sensitive and specific cellular and molecular imaging of cancer. In some circumstances, PA imaging techniques have the ability to provide greater spatial and temporal resolution than currently adapted modalities such as optical imaging, magnetic resonance imaging (MRI), and radionuclide imaging.

Another such example has been previously described for in-vivo cholesterol imaging in atherosclerotic plaques, an important pathophysiologic process leading to the high-mortality/morbidity sequalae of cardiovascular diseases, including myocardial infarction, stroke, and death. Characterization of plaques which have a higher likelihood of rupture, and therefore downstream embolization resulting in the previously listed events, is pivotal to better understand and treat the growing population of individuals with cardiovascular disease. PA imaging can and has been used to determine molecular composition of plaques.

In some embodiments, the devices and methods disclosed herein can be applied to a drug delivery such as liposome-assisted drug delivery or gene therapy when the radiation acts as a hyperthermic trigger to release therapeutic compounds (such as, for example, drugs or genes) from liposomal formulations. More specifically, when thermally releasing the drug or gene contents from the liposome at the target site by using a radiation beam, the heat generation from PA of the radiation beam on the medium can be minimized using the devices and methods disclosed herein. For example, a wavelength λ₁ can be chosen for releasing the drug or gene from the liposomal formulations. Then a wavelength λ₂ can be chosen so that the absorptivities of the medium at wavelength λ₁ and wavelength λ₂ are the same or substantially the same. In this way, the heat exerted on the medium due to PA is minimized or canceled.

In some embodiments, the devices and methods disclosed herein can be applied to site-specific decomposition of prodrugs when the radiation acts as a trigger to release the parent drug from the prodrug due to photochemistry on the prodrug linkage. A prodrug is a protected form of a parent drug. The protecting group on the parent drug may be photo-labile and undergoes photochemical reactions to release the parent drug. More specifically, when using radiation beam to release the prodrug at a specific site inside a patient, the heat generation from PA of the radiation beam on the medium can be minimized by using the devices and methods disclosed herein. For example, a wavelength Au can be chosen for releasing the parent drug from the prodrug. Then a wavelength λ₂ can be chosen so that the absorptivities of the medium at wavelength λ₁ and wavelength λ₂ are the same or substantially the same. In this way, the heat exerted on the medium due to PA is minimized or canceled.

In some embodiments, the devices and methods disclosed herein can be applied to site-specific laparoscopic surgery when the radiation triggers micro bubbles to act as a scalpel to remove body tissues, such as, for example, a small piece of tissue or an artery plaque. More specifically, a radiation beam can be used to generate/move/enlarge/collapse ultrasonic micro bubbles at specific site inside a patient's body. Although the heat generated around the ultrasonic micro bubbles are beneficial to remove tissues, the heat generated in the medium around the surgery site can be harmful to the patient. The heat generation from PA of the radiation beam on the medium can be minimized by using the devices and methods disclosed herein. For example, a wavelength λ₁ can be chosen to generate/move/enlarge/collapse ultrasonic micro bubbles. Then a wavelength λ₂ can be chosen so that the absorptivities of the medium at wavelength λ₁ and wavelength λ₂ are the same or substantially the same. In this way, the heat exerted on the medium due to PA is minimized or canceled.

In order that the invention described herein may be more fully understood, the following examples are set forth. It should be understood that these examples are for illustrative purposes only and are not to be construed as limiting this invention in any manner.

### NUMBERED EMBODIMENTS

Embodiment 1. A photoacoustic system comprising:
(a) an amplitude modulator, the amplitude modulator being configured to modulate (i) a first amplitude and a first phase of a first light beam, and (ii) a second amplitude and a second phase of a second light beam; and
(b) a light transmitter linked to the amplitude modulator, the light transmitter being configured to collimate and merge the first light beam and the second light beam, thereby producing a merged single beam.

Embodiment 2. A photoacoustic system comprising:
(a) an amplitude modulator, the amplitude modulator being configured to modulate (i) a first amplitude and a first phase of a first light beam, and (ii) a second amplitude and a second phase of a second light beam;
(b) a light transmitter linked to the amplitude modulator, the light transmitter being configured to collimate and merge the first light beam and the second light beam, thereby producing a merged single beam, wherein the light transmitter comprises a beam splitter configured to reflect a first fraction of the merged single beam in a first direction and direct a second fraction of the merged single beam to a second direction;
(c) a photodetector linked to the light transmitter, the photodetector being configured to monitor the first fraction of the merged single beam at a rate from 50 Hz to 2 GHz in real time;
(d) an acoustic signal monitor, the acoustic signal monitor being configured to monitor acoustic signals generated by the second fraction of the merged single beam; and
(e) a data processor linked to the amplitude modulator, the photodetector, and/or the acoustic signal monitor, the data processor being configured to (i) analyze data received from the photodetector and/or the acoustic signal monitor, and (ii) provide feedbacks to the amplitude modulator in real time.

Embodiment 3. The photoacoustic system of Embodiment 1 or Embodiment 2, further comprising:
a light source linked to the amplitude modulator, the light source being configured to emit at least the first light beam and the second light beam.

Embodiment 4. The photoacoustic system of Embodiment 3, wherein the light source is configured to produce continuous-wave light outputs at spectral region from ultraviolet to far-IR.

Embodiment 5. A photoacoustic system, comprising:
(a) a first light source and a second light source, wherein the first light source emits a first light beam, wherein the second light source emits a second light beam;
(b) an amplitude modulator coupled to the first and second light sources, the amplitude modulator being configured to modulate (i) a first amplitude and a first phase of the first light beam, and (ii) a second amplitude and a second phase of the second light beam;
(c) a light transmitter, the light transmitter being configured to collimate and merge the first light beam and the second light beam, thereby producing a merged single beam, wherein the light transmitter comprises a beam splitter configured to reflect a first fraction of the merged single beam in a first direction and direct a second fraction of the merged single beam to a second direction;
(d) a photodetector coupled to the light transmitter, the photodetector being configured to monitor the first fraction of the merged single beam at a rate from 50 Hz to 2 GHz in real time;
(e) an acoustic signal monitor, the acoustic signal monitor being configured to monitor acoustic signals generated by the second fraction of the merged single beam; and
(f) a data processor linked to the amplitude modulator, the photodetector, and/or the acoustic signal monitor, the data processor being configured to (i) analyze data received from the photodetector and/or the acoustic signal monitor, and (ii) provide feedbacks to the amplitude modulator in real time.

Embodiment 6. The photoacoustic system of Embodiment 5, wherein each of the first light source and the second light source is configured to produce continuous-wave light outputs at spectral region from ultraviolet to far-IR.

Embodiment 7. The photoacoustic system of any one of Embodiments 3, 4 and 6, wherein the first and second light beams are distributed feedback (DFB) semiconductor lasers.

Embodiment 8. The photoacoustic system of any one of Embodiments 3-7, wherein the light source is configured to tune a first wavelength of the first light beam and the second wavelength of the second light beam, wherein the first light source is configured to tune the first wavelength of the first light beam, and wherein the second light source is configured to tune the second wavelength of the second light beam.

Embodiment 9. The photoacoustic system of any one of Embodiments 1-8, wherein the first fraction of the merged single beam is from 1% to 15% of the merged single beam, and wherein the second fraction of the merged single beam is from 85% to 99% of the merged single beam.

Embodiment 10. The photoacoustic system of any Embodiment 9, wherein the first fraction of the merged single beam is about 10% of the merged single beam, and wherein the second fraction of the merged single beam is about 90% of the merged single beam.

Embodiment 11. The photoacoustic system of any one of Embodiments 1-10, wherein the first amplitude is modulated with a first sinusoidal function, and wherein the second amplitude is modulated with a second sinusoidal function.

Embodiment 12. The photoacoustic system of Embodiment 11, wherein the difference between the phase and the second is about 180 degree.

Embodiment 13. The photoacoustic system of Embodiment 11, wherein the difference between the first phase and the second phase is from 175 degree to 185 degree.

Embodiment 14. The photoacoustic system of any one of Embodiments 1-13, wherein the amplitude modulator comprises one or more quartz crystal oscillators configured to generate waveforms of a sinusoidal-wave output or a square-wave output.

Embodiment 15. The photoacoustic system of Embodiment 14, further comprising:
one or more capacitor couplers, each of the one or more capacitor couplers being configured to couple the waveforms of the sinusoidal-wave output or the square-wave output to one or more DC currents, respectively, wherein each of the DC currents is the DC power supply for the light source, the first light source, or the second light source.

Embodiment 16. The photoacoustic system of any one of Embodiments 1-15, further comprising an optical fiber coupler and a single-mode optical fiber, wherein the merged single light beam or the second fraction of the merged single light beam is coupled to the single-mode optical fiber via the optical fiber coupler.

Embodiment 17. The photoacoustic system of Embodiment 16, wherein the optical fiber comprises numeric aperture of 0.22, and wherein the optical fiber is terminated with a physical contact (PC) polish connector at each end.

Embodiment 18. The photoacoustic system of any one of Embodiments 1-17, wherein the acoustic signal monitor is a microphone or several microphones in an array configuration.

Embodiment 19. A method of modulating light beams for a photoacoustic system, comprising:
(a) obtaining a first absorption spectrum of a sample and a second absorption spectrum of a surrounding medium of the sample;
(b) at least based on the first and second absorption spectra, selecting (i) a first wavelength, wherein the sample exhibits a detectable first absorbance at the first wavelength, and wherein the surrounding medium exhibits a detectable second absorbance at the first wavelength; and (ii) a second wavelength, wherein the sample exhibits a detectable third absorbance at the second wavelength, wherein the surrounding medium exhibits a detectable fourth absorbance at the second wavelength, wherein the third absorbance is no more than 10% of the first absorbance, and wherein the fourth absorbance from 95% to 105% of the second absorbance;
(c) providing a first modulated light beam having the first wavelength and a second modulated light beam having the second wavelength, wherein the second modulated light beam is phase shifted from the first modulated light beam;
(d) merging and collimating the first and second modulated light beams, thereby providing a merged single light beam; and
(e) radiating a first fraction of the merged single light beam on the sample and the surrounding medium.

Embodiment 20. The method of Embodiment 19, further comprising:
after (d) and before (e): splitting the merged single light beam into at least the first fraction and a second fraction; and
sampling the second fraction by a photodetector at a sampling frequency from 50 Hz to 2 GHz.

Embodiment 21. The method of Embodiment 20, further comprising:
after the sampling, providing feedback information to an amplitude modulator; and
modulating, by the amplitude modulator and based on at least the feedback information, the first and/or second modulated light beams.

Embodiment 22. The method of any One of Embodiments 19-21, further comprising:
after (d) and before (e): radiating the first fraction of the merged single light beam on the surrounding medium;
monitoring, by an acoustic signal monitor, a medium acoustic excitation generated from the surrounding medium; and
further modulating, by the amplitude modulator and based on the medium acoustic excitation, the first and/or second modulated light beams.

Embodiment 23. The method of any one of Embodiments 19-22, wherein the modulating is performed mechanically and/or electronically, and wherein the amplitude modulator varies an amplitude and a phase of the first modulated light beam or the second modulated light beam.

Embodiment 24. The method of Embodiment 23, wherein the modulating is performed electronically by a transistor-transistor logic signal carrying information of a modulation frequency, a depth and the phase of the first modulated light beam or the second modulated light beam.

Embodiment 25. The method of any one of Embodiments 19-24, wherein the second modulated light beam is phase shifted from the first modulated light beam by about 180 degree.

Embodiment 26. The method of Embodiment any one of Embodiments 19-24, wherein the second modulated light beam is phase shifted from the first modulated light beam from 175 degree to 185 degree.

Embodiment 27. The method of any one of Embodiments 19-26, wherein the first and second modulated light beams are modulated at the same or substantially the same modulation frequency.

Embodiment 28. The method of any one of Embodiments 19-26, wherein the first and second modulated light beams are modulated at a modulation frequency from 10 kHz to 100 kHz.

Embodiment 29. The method of any one of Embodiments 19-27, wherein the first modulated light beam is modulated by a first injection current, wherein the second modulated light beam is modulated by a second injection current, and wherein each of the first injection current and the second injection current independently comprises a sinusoidal or square waveform signal.

Embodiment 30. The method of any one of Embodiments 19-29, wherein photoacoustic effects on the medium from the first and second wavelengths are the same or substantially the same.

Embodiment 31. The method of any one of Embodiments 19-30, wherein the photoacoustic system comprises the amplitude modulator and the acoustic signal monitor.

### EXAMPLES

### Example 1. Measurements of Ammonia in Humid Air Samples

One example uses the dual-wavelength PA effect to measure ammonia in humid air samples. Since water is always present in the atmosphere, it has been a great challenge to measure ammonia accurately in humid air samples. The dual-wavelength PA technique provides a method to measure ammonia concentrations without the interferences from the water content, thus improving sensitivity and accuracy of ammonia detection.

### Example 2. Selection of the Frequencies for Two Light Beams

According to the NIST Chemistry Web book, ammonia molecule has a strong absorption at 1630 cm⁻¹ and a weak absorption at 1640 cm⁻¹, while water has a medium absorption at 1640 cm⁻¹ and a weak absorption at 1630 cm⁻¹. Thus, two IR lasers are selected for ammonia measurement: one at 1640 cm⁻¹ and the other at 1630 cm⁻¹. The light beams from the two lasers are merged into one beam, which is subsequently guided into a photoacoustic resonator with a specific resonance frequency ƒ. The resonator serves as the sample cell during the measurement. A microphone is used as the detector located at the peak of the photoacoustic resonance.

### Example 3. Modulation of the Two Light Beams

To measure the PA effect of a humid air sample without any ammonia, the two IR lasers are amplitude-modulated via a TTL control over their power supplies at the resonance frequency of ƒ, and the phase shift between the two lasers are initially set at 180°. Relative humidity of the air sample is set at any appreciate value, such as, for example, 50%. By monitoring the PA signals with a microphone as the detector, light intensities and phase shifts of the two laser beams are adjusted until the PA effect disappeared due to the cancellation of the PA effect of water content at the two wavelengths. Since light absorptions of ammonia at 1640 cm⁻¹ and 1630 cm⁻¹ are significantly different from water, the PA effect from ammonia remains strong in this approach. By calibrating the PA effect of ammonia with the known-concentration standards, this device is used to measure ammonia of air samples at any humidity.

Best examples are using endogenous chromophores (hemoglobin, melanin, lipids, etc.)-PA imaging of Melanomas: Dual-wavelength PA imaging as described above differentiates melanin containing melanomas from surrounding hemoglobin containing vascular structures/normal tissues due to the optical absorption differences. For example, at a wavelength of 584 nm, both melanin and hemoglobin have high absorption, while at 764 nm, melanin alone maintains this higher absorption. As detailed above, melanoma can be differentiated from surrounding vasculature with the PA method. This application for detection of malignancies is especially important given the high metastatic potential specifically of melanoma. The PA method can be further employed to detecting metastases and forgo invasive sampling of lymphatic tissues, for example. Furthermore, PA can be adapted to assess for hematogenous spread of melanoma through blood sampling. Although many limitations currently exist and validation is needed, circulating tumor cells offer alternative methods for evaluation of metastatic disease. Minimally invasive techniques in mice models have utilized in vivo approaches to assess such a concept. Optical fibers can be inserted into blood vessels to obtain PA signals at various wavelengths to enable spectroscopic detection of melanoma cells in the bloodstream. This PA flow cytometry technique combats the limitation of small volume blood sampling.

What is claimed is:

1. A photoacoustic system comprising:
(a) an amplitude modulator, the amplitude modulator being configured to modulate (i) a first amplitude and a first phase of a first light beam, and (ii) a second amplitude and a second phase of a second light beam;
(b) a light transmitter linked to the amplitude modulator, the light transmitter being configured to collimate and merge the first light beam and the second light beam, thereby producing a merged single beam, wherein the light transmitter comprises a beam splitter configured to reflect a first fraction of the merged single beam in a first direction and direct a second fraction of the merged single beam to a second direction;
(c) a photodetector linked to the light transmitter, the photodetector being configured to monitor the first fraction of the merged single beam at a rate from 50 Hz to 2 GHz in real time;
(d) an acoustic signal monitor, the acoustic signal monitor being configured to monitor acoustic signals generated by the second fraction of the merged single beam; and
(e) a data processor linked to the amplitude modulator, the photodetector, and/or the acoustic signal monitor, the data processor being configured to (i) analyze data received from the photodetector and/or the acoustic signal monitor, and (ii) provide feedbacks to the amplitude modulator in real time.

2. The photoacoustic system of claim 1, further comprising:
a light source linked to the amplitude modulator, the light source being configured to emit at least the first light beam and the second light beam.

3. The photoacoustic system of claim 2, wherein the light source is configured to produce continuous-wave light outputs at spectral region from ultraviolet to far-IR.

4. The photoacoustic system of claim 2, wherein the light source is configured to tune a first wavelength of the first light beam and the second wavelength of the second light beam, wherein the first light source is configured to tune the first wavelength of the first light beam, and wherein the second light source is configured to tune the second wavelength of the second light beam.

5. The photoacoustic system of claim 1, wherein the first amplitude is modulated with a first sinusoidal function, and wherein the second amplitude is modulated with a second sinusoidal function.

6. The photoacoustic system of claim 5, wherein the difference between the first phase and the second phase is about 180 degree.

7. The photoacoustic system of claim 1, wherein the amplitude modulator comprises one or more quartz crystal oscillators configured to generate waveforms of a sinusoidal-wave output or a square-wave output.

8. The photoacoustic system of claim 7, further comprising:
one or more capacitor couplers, each of the one or more capacitor couplers being configured to couple the waveforms of the sinusoidal-wave output or the square-wave output to one or more DC currents, respectively, wherein each of the DC currents is the DC power supply for the light source, the first light source, or the second light source.

9. The photoacoustic system of claim 1, further comprising an optical fiber coupler and a single-mode optical fiber, wherein the merged single light beam or the second fraction of the merged single light beam is coupled to the single-mode optical fiber via the optical fiber coupler.

10. A photoacoustic system, comprising:
(a) a first light source and a second light source, wherein the first light source emits a first light beam, wherein the second light source emits a second light beam;
(b) an amplitude modulator coupled to the first and second light sources, the amplitude modulator being configured to modulate (i) a first amplitude and a first phase of the first light beam, and (ii) a second amplitude and a second phase of the second light beam;
(c) a light transmitter, the light transmitter being configured to collimate and merge the first light beam and the second light beam, thereby producing a merged single beam, wherein the light transmitter comprises a beam splitter configured to reflect a first fraction of the merged single beam in a first direction and direct a second fraction of the merged single beam to a second direction;
(d) a photodetector coupled to the light transmitter, the photodetector being configured to monitor the first fraction of the merged single beam at a rate from 50 Hz to 2 GHz in real time;
(e) an acoustic signal monitor, the acoustic signal monitor being configured to monitor acoustic signals generated by the second fraction of the merged single beam; and
(f) a data processor linked to the amplitude modulator, the photodetector, and/or the acoustic signal monitor, the data processor being configured to (i) analyze data received from the photodetector and/or the acoustic signal monitor, and (ii) provide feedbacks to the amplitude modulator in real time.

11. The photoacoustic system of claim 10, wherein each of the first light source and the second light source is configured to produce continuous-wave light outputs at spectral region from ultraviolet to far-IR.

12. A method of modulating light beams for a photoacoustic system, comprising:
(a) obtaining a first absorption spectrum of a sample and a second absorption spectrum of a surrounding medium of the sample;
(b) at least based on the first and second absorption spectra, selecting (i) a first wavelength, wherein the sample exhibits a detectable first absorbance at the first wavelength, and wherein the surrounding medium exhibits a detectable second absorbance at the first wavelength; and (ii) a second wavelength, wherein the sample exhibits a detectable third absorbance at the second wavelength, wherein the surrounding medium exhibits a detectable fourth absorbance at the second wavelength, wherein the third absorbance is no more than 10% of the first absorbance, and wherein the fourth absorbance from 95% to 105% of the second absorbance;
(c) providing a first modulated light beam having the first wavelength and a second modulated light beam having the second wavelength, wherein the second modulated light beam is phase shifted from the first modulated light beam;
(d) merging and collimating the first and second modulated light beams, thereby providing a merged single light beam; and
(e) radiating a first fraction of the merged single light beam on the sample and the surrounding medium.

13. The method of claim 12, further comprising:
after (d) and before (e): splitting the merged single light beam into at least the first fraction and a second fraction; and
sampling the second fraction by a photodetector at a sampling frequency from 50 Hz to 2 GHz.

14. The method of claim 13, further comprising:
after the sampling, providing feedback information to an amplitude modulator; and
modulating, by the amplitude modulator and based on at least the feedback information, the first and/or second modulated light beams.

15. The method of claim 13, further comprising:
after (d) and before (e): radiating the first fraction of the merged single light beam on the surrounding medium;
monitoring, by an acoustic signal monitor, a medium acoustic excitation generated from the surrounding medium; and
further modulating, by the amplitude modulator and based on the medium acoustic excitation, the first and/or second modulated light beams.

16. The method of claim 12, wherein the modulating is performed electronically by a transistor-transistor logic signal carrying information of a modulation frequency, a depth and the phase of the first modulated light beam or the second modulated light beam.

17. The method of claim 12, wherein the second modulated light beam is phase shifted from the first modulated light beam by about 180 degree.

18. The method of claim 12, wherein the first and second modulated light beams are modulated at the same or substantially the same modulation frequency.

19. The method of claim 12, wherein the first modulated light beam is modulated by a first injection current, wherein the second modulated light beam is modulated by a second injection current, and wherein each of the first injection current and the second injection current independently comprises a sinusoidal or square waveform signal.

20. The method of claim 12, wherein photoacoustic effects on the medium from the first and second wavelengths are the same or substantially the same.
